(19) United States
(12) Patent Application Publication
(10) Pub. No.: US 2008/0084989 A1
(43) Pub. Date: Apr. 10, 2008

(54) Intelligent Reusable Dialog Components for Converged Dialog and Session Control

(75) Inventor: Girish Dhanakshirur, Delray Beach, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/534,331

(22) Filed: Sep. 22, 2006

(51) Int. Cl. H04M 3/00

(52) U.S. Cl. 379/309

(57) ABSTRACT

A method of handling calls within an interactive voice response system. The method can include conducting a dialog with a calling party over an established call and, during the dialog, determining that an agent is available. The method further can include interrupting the dialog and, based upon a response from the calling party, selectively terminating the dialog and transferring the call to the agent.

### BACKGROUND OF THE INVENTION

Within a call center, calls typically are terminated in a media server, which provides voice response functions. The media server can function as an interactive voice response (IVR) system, often implemented as a voice browser executing one or more voice-based, self-serve applications. Over an established telephone call connected to the media server, and more particularly the voice browser, the user can respond to prompts and select various options using touch tone and/or voice input. By interacting with the self-serve application, the user can obtain information, reach a particular termination point, or the like.

A flight reservation system is one example of a self-serve application which can be made available on a media server. A user can place a call to a call center to make a reservation. If all agents are busy assisting other callers, the user can be presented with the option of being transferred to a self-serve application. The user can work with the self-serve application to make a flight reservation or perform another transaction without the assistance of a human being. If the user accepts this option, typically the call is transferred to a voice browser executing the appropriate self-serve application.

Once connected, the user can begin the process of making a reservation without the help or guidance of a human being. If, however, a human agent does become available while the user is engaged in a dialog with the voice browser and self-serve application, the user remains unaware that a human agent is available. While the user may prefer to deal with a human agent over the self-serve application, the user is not afforded an opportunity to make that decision.

It would be beneficial to provide a technique for incorporating telephony events with voice-based applications in a manner that addresses the limitations described above.

### BRIEF SUMMARY OF THE INVENTION

The present invention provides method(s), system(s), and apparatus relating to the incorporation and processing of telephony events during an ongoing dialog as conducted by an interactive voice response (IVR) system. One embodiment of the present invention can include a method of handling calls within an IVR system. The method can include conducting a dialog with a calling party over an established call and, during the dialog, determining that an agent is available. The method also can include interrupting the dialog and, based upon a response from the calling party, selectively transferring the call to the agent.

Another embodiment of the present invention can include a system for call handling. The system can include an automated call distributor configured to detect agent availability and a Hypertext Transfer Protocol (HTTP) servlet hosting at least one reusable dialog component (RDC). The system further can include a Session Initiation Protocol (SIP) servlet that provides agent availability events from the automated call distributor to the RDC. Responsive to receiving an agent availability event, the RDC, during an ongoing dialog conducted over an established call, can cause an audible notification of the event to be provided over the established call.

Yet another embodiment of the present invention can include a machine readable storage being programmed to cause a machine to perform the various steps and/or functions described herein.

### BRIEF DESCRIPTION OF THE SEVERAL VIEWS OF THE DRAWINGS

FIG. 1 is a block diagram illustrating a call handling system in accordance with one embodiment of the present invention.

FIG. 2 is a flow chart illustrating a method of call handling in accordance with another embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system”. Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The embodiments disclosed herein relate to call handling and the integration and processing of telephony events received during a dialog conducted with an interactive voice response (IVR) system. In accordance with the inventive arrangements disclosed herein, telephony events can be used as a means for interrupting ongoing dialogs between a user and an IVR. Based upon a user response obtained when such an interruption occurs, the currently active dialog can be continued or terminated so that further call processing and/or call routing can be performed.

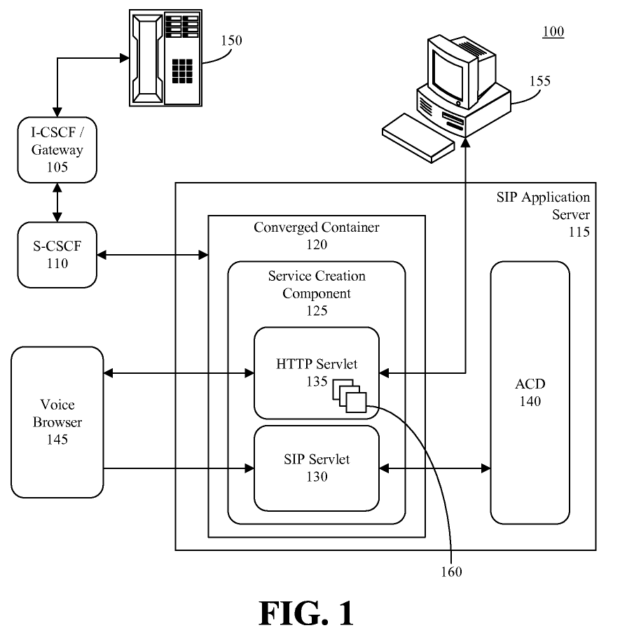

FIG. 1 is a block diagram illustrating a call handling system 100 in accordance with one embodiment of the present invention. In accordance with the inventive arrangements disclosed herein, the call handling system 100 can be implemented in accordance with Internet Protocol (IP) Multimedia Subsystem (IMS) architecture and Session Initiation Protocol (SIP) standard. SIP can be used to negotiate an interactive communication session between two peers and provides a foundation for IMS. SIP also can be used as a control protocol within IP telephony networks. Accordingly, the system 100 can include an Interrogating-Call Session Control Function (I-CSCF) 105, a Serving-Call Session Control Function (S-CSCF) 110, a SIP application server 115, as well as a voice browser 145.

In general, CSCFs are specific types of SIP servers, which are used to process SIP signaling packets in an IMS network. The I-CSCF 105 is a SIP proxy located at the edge of a domain. The I-CSCF 105 can serve as the first point of contact for incoming call signaling and callers. As such, the I-CSCF 105 can query the Home Subscriber Server (HSS) (not shown) to find the correct S-CSCF 110 for handling a given call. The I-CSCF 105 can provide functions such as caller registration, routing and forwarding of SIP messages, as well as charging. The S-CSCF 110 provides session control for subscribers accessing services within the IMS network. The S-CSCF 110 is responsible for interacting with network databases such as the HSS for mobility and Access, Authorization, and Accounting (AAA) servers for security. As part of the SIP registration process, each user is allocated an S-CSCF 110 that will reside in the Home Public Land Mobile Network (HPLMN) in which that subscriber's profile is held.

The SIP application server 115 can provide a carrier class application server environment. In one embodiment, the SIP application server 115 can provide a Java-based SIP servlet container architecture. The SIP application server 115 effectively separates software-based IP services from network-based hardware resources. In one embodiment, the SIP application server 115 can be implemented as the WebSphere Application Server (WAS) which is commercially available from International Business Machines Corporation of Armonk, N.Y. The WAS provides support for SIP Servlets, Hypertext Transfer Protocol (HTTP) servlets, portlets, Java Server Pages (JSPs), as well as Java Server Faces (JSFs). It should be appreciated that other application servers also can be used and that reference to any particular application server or container is for purposes of illustration only and should not be viewed as a limitation of the present invention.

In any case, the SIP application server 115 can include a converged container 120 capable of supporting both HTTP servlets and SIP servlets. Within the converged container 120, a service creation component 125 can be included. The service creation component 125 can be configured to handle events such as “dolnvite” in response to incoming INVITE requests. For example, the service creation component 125, which can include one or more SIP servlets, can extend the SIPServlet interface and implement the dolnvite method. When a call arrives, the converged container 120, i.e., WAS, can forward the call to the dolnvite method for further processing. The dolnvite method can check for the Iflnitial flag, i.e., to determine whether the converged container 120 has any prior knowledge of internal routing. The service creation component 125 can include a SIP servlet 130, an HTTP servlet 135, as well as deployment descriptors (not shown) pertaining to the SIP servlet 130 and the HTTP servlet 135.

In illustration, an application and/or service referred to as Call Director, for example, can be packaged in CallDirectory.sar, which can be a service creation component. As the service creation component lives within the converged container, it can include both SIP servlets and HTTP servlets. The SIP servlet behavior can be controlled by a SIP deployment descriptor sip.xml, which can specify, i.e., the dolnvite mappings, while the HTTP servlet behavior can be controlled by a Web Deployment descriptor web.xml. Both can be packaged within the .SAR file, which can constitute the service creation component.

The SIP servlet 130 and the HTTP servlet 135 can share state through application session objects representing instances of the application. The HTTP servlet 135 can be implemented as a JSP, for example, and host one or more reusable dialog components (RDCs) 160. The HTTP servlet 135 further can register as the source for generating Notify events when a network event is generated and, further, can register a callback. The registered callback allows the RDC(s) 160 to callback to the SIP servlet 130 to indicate that a particular dialog has been terminated and request that the SIP servlet 130 continue the call leg.

In general, the RDCs 160 encapsulate well-tried elements of speech user interface design. Each RDC 160, for example, can collect a particular type of information, such as an address, from the user. The RDCs 160 ensure that all the required interactions for guaranteeing the completeness, such as validity and canonicalization format, of the data are provided. An address RDC, for example, would provide the error handling and logic needed for obtaining all aspects of a user address such as the street address, apartment number, city, state, and zip code.

More particularly, each RDC 160 can include a data model, speech-specific assets like grammars and prompts, configuration files, and the dialog logic needed to collect one or more items of information from a user. The RDCs 160 generate the voice markup language, i.e. Voice Extensible Markup Language (VoiceXML), that can be executed by the voice browser 145. Speech applications, i.e., voice-based, self-serve applications (self-serve applications), can be written by instantiating one or more RDCs 160. In accordance with the embodiments disclosed herein, one or more, or all, RDCs 160 used within the service creation component 125 can be configured to include additional interfaces. In one embodiment, selected RDCs 160 can include a listener object and a callback object.

A SIP servlet application such as an Automated Call Distributor (ACD) 140 application/service can be implemented to run on top of the SIP Application Server 115. The ACD 140 can distribute incoming calls to various endpoints or extensions. The distribution of calls by the ACD 140 can be determined based upon internal logic or rules in the application. Typically, calls are routed in sequence to the first available human agent or can be queued until such time that a human agent is available. In another embodiment, calls can be transferred to a self-serve application, i.e., the voice browser 145, in the event that a human agent is unavailable.

The voice browser 145 implements an interactive voice user interface with the user or caller. The voice browser 145 can execute voice markup language provided from the RDCs 160. Further, the voice browser 145 can include speech processing and generation resources (not shown) such as a speech recognition engine, a text-to-speech engine, and/or an audio playback engine for interacting with a caller over the established call in the course of a dialog.

In operation, a user can place a call from telephone 150 to the call handling system 100, which can be implemented or disposed within a call center. The telephone 150 can be a SIP-enabled phone, in which case the telephone 150 can be directly connected with the system 100, or a conventional telephone, in which case the call can be processed through a Public Switched Telephone Network (PSTN) bridge. In any case, the call can be routed to the ACD 140. If no human agents are available to take the call, the system 100 can prompt the user as to whether he or she would like to continue the transaction using a self-serve application as provided or implemented through the voice browser 145.

If the user chooses to continue the call using the self-serve application, the call can be routed to the voice browser 145, which can begin executing voice markup language as obtained from one or more of the RDCs 160 hosted by the HTTP servlet 135. At some point during the dialog conducted between the user and the voice browser 145 over the telephone call, if a human agent becomes available, the ACD 140 can generate an event. Through the listener object, the RDCs 160 will detect such an event while the dialog with the caller is in progress or ongoing.

Responsive to detecting such an event, the RDCs 160 can interrupt the dialog and generate appropriate voice markup language that, when executed by the voice browser 145, notifies the user of the availability of a human agent. The RDCs 160 further can generate appropriate voice markup language to query the user as to whether he or she would like to continue using the self-help application or be transferred to an available human agent. If the user wishes to continue with a human agent, the RDCs 160 can terminate the dialog, callback the SIP servlet 130 to take control of the call leg. The SIP servlet 130 then can route the call appropriately, i.e., back to the ACD 140. The ACD 140 then can connect the call to the available human agent, i.e., to a computer system 155 or other communication device or network node associated with the human agent.

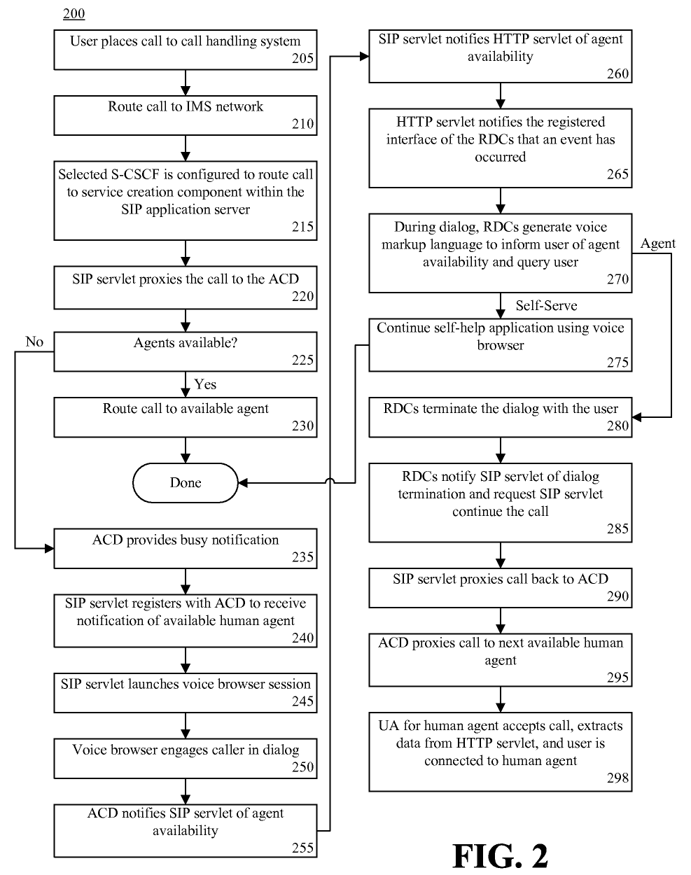

FIG. 2 is a flow chart illustrating a method 200 of call handling in accordance with another embodiment of the present invention. The method 200 can be implemented using the system described with reference to FIG. 1. Accordingly, in step 205, a user can place a call to a call center including a call handling system as depicted in FIG. 1. An invite can be provided to the I-CSCF. In step 210, the call can be routed to an IMS network. The call can pass through a PSTN bridge if initiated from a non-SIP-enabled telephone or can be directly routed to the IMS network if initiated from a SIP-enabled telephone or device. In any case, the I-CSCF can handle the call and query the HSS to find the appropriate S-CSCF to which the call is to be forwarded. An invite can be provided to the selected S-CSCF.

In step 215, the selected S-CSCF, as determined by the I-CSCF, can be configured to route the call to the service creation component that is hosted in the SIP application server. An invite can be provided from the S-CSCF to the service creation component. In step 220, the service creation component can handle the “dolnvite” and “iflnitial”. The SIP servlet within the service creation component can determine that the call should be routed to the ACD and, accordingly, proxy the call to the ACD.

In step 225, the ACD determines whether any human agents are available. If so, the call can be routed to an available human agent in step 230 and end. If not, in step 235, the ACD can respond to the INVITE request from the SIP servlet with a 486 busy notification. In step 240, the SIP servlet can register with the ACD, via the SIP event SUBSCRIBE, to be notified when a human agent becomes available.

In step 245, the SIP servlet can launch a voice browser session which executes the self-serve application. The voice browser can be configured with a predetermined universal resource locator (URL) which corresponds to the HTTP servlet hosting the RDCs. In step 250, the voice browser can obtain voice markup language from the RDCs and execute the voice markup language to engage the caller in a dialog. Through this dialog, the user can begin a transaction, whether a banking transaction, a flight reservation, or the like, with the self-serve application.

In step 255, the ACD can determine that a human agent is available and notify the SIP servlet of the agent availability. In step 260, the SIP servlet can notify the HTTP servlet of the agent availability. In step 265, the HTTP servlet can call the registered interface to the RDCs to inform the RDCs that a telephony network event has occurred, particularly that a human agent is now available. For example, the HTTP servlet can call the listener object of the RDCs.

In step 270, during the established or ongoing dialog, the RDC, responsive to receiving the event, can generate voice markup language that, when executed by the voice browser, informs the user of the availability of the human agent. That is, the dialog that was in process can be interrupted with a notification or prompt from the voice browser that a human agent is available. Further voice markup language can be generated to query the user as to whether he or she wishes to continue using the self-serve application or be transferred to an available human agent.

In step 275, in the case where the user wishes to continue working with the self-serve application, the call remains connected to the voice browser and the method can end as the user can complete the transaction using the self-serve application. In step 280, where the caller has requested to continue with a human agent, the RDCs can terminate the dialog with the user. Accordingly, in step 285, the RDCs, via the callback object, can notify the SIP servlet that the dialog has been terminated and request that the SIP servlet continue the call.

In step 290, the SIP servlet can proxy the call back to the ACD. In step 295, the ACD can proxy the call to the next available agent. In step 298, the computing system associated with the human agent, executing appropriate software, i.e., client software such as a user agent (UA), can accept the INVITE. Any information that has been collected from the user and stored within the HTTP servlet during the course of the dialog with the self-serve application can be obtained or extracted by the client software and, thus, provided or otherwise made available to the computer system of the human agent for use in continuing the transaction initially started by the user with the self-serve application. Possible information that can be extracted can include, but is not limited to, the current state of the call as well as any fields of the RDC that were filled in during the course of the dialog. The communication device or computer system of the human agent is then connected with the telephone call and the user. The user (calling party), once connected with the human agent, can complete the transaction started with the self-serve application.

The embodiments disclosed herein provide method(s), system(s), and apparatus which facilitate the integration of telephony events and IVR systems. Events generated by an ACD can be provided, or made available, to RDCs. While the RDCs carry on a dialog with a user through a voice browser, the RDCs can respond to the event. The RDC can interrupt the dialog and generate appropriate voice markup language to inform the user of the event and, further, generate appropriate voice markup language to query the user to determine which of a plurality of possible actions should be pursued.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A method of handling calls within an interactive voice response system comprising:
conducting a dialog with a calling party over an established call;
during the dialog, determining that an agent is available;
interrupting the dialog; and
based upon a response from the calling party, selectively terminating the dialog and transferring the call to the agent.

2. The method of claim 1, wherein conducting a dialog further comprises:
routing the call to an automatic call distributor;
determining that no agent is available; and
registering a Session Initiation Protocol (SIP) servlet for receiving agent availability events from the automatic call distributor.

3. The method of claim 2, wherein conducting a dialog further comprises:
launching a voice browser session; and
a hypertext transfer protocol (HTTP) servlet that hosts a reusable dialog component launching the reusable dialog component, wherein the reusable dialog component provides voice markup language for use with the voice browser session to implement the dialog.

4. The method of claim 3, wherein determining that an agent is available further comprises:
the SIP servlet receiving an event indicating that the agent is available, wherein the event originates from the automatic call distributor;
the HTTP servlet receiving a notification of the availability of the agent from the SIP servlet; and
the reusable dialog component receiving a notification of the availability of the agent from the HTTP servlet.

5. The method of claim 4, wherein interrupting the dialog further comprises the reusable dialog component, responsive to receiving the event from the HTTP servlet, generating voice markup language for use in the voice browser session to prompt the calling party as to the availability of the agent.

6. The method of claim 5, wherein selectively terminating the dialog and transferring the call to the agent further comprises the reusable dialog component terminating the dialog based upon a response from the calling party.

7. The method of claim 6, wherein selectively terminating the dialog and transferring the call to the agent further comprises:
the reusable dialog component notifying the SIP servlet that the dialog is terminated and requesting that the SIP servlet continue the call; and
the SIP servlet proxying the call to the automatic call distributor for routing to the agent.

8. The method of claim 7, further comprising providing data collected by the reusable dialog component to a client system associated with the agent.

9. A call handling system comprising:
an automated call distributor configured to detect agent availability and generate agent availability events;
a Hypertext Transfer Protocol (HTTP) servlet hosting at least one reusable dialog component; and
a Session Initiation Protocol (SIP) servlet that provides agent availability events from the automated call distributor to the reusable dialog component;
wherein, responsive to receiving an agent availability event, the reusable dialog component, during an ongoing dialog conducted over an established call, causes an audible notification of the event to be provided over the established call.

10. The call handling system of claim 9, wherein the reusable dialog component comprises a listener object configured to receive the agent availability event and a callback object configured to notify the SIP servlet that the ongoing dialog has been terminated and request that the SIP servlet route the call to the automated call distributor for transfer to an available agent.

11. The call handling system of claim 10, wherein the reusable dialog component, responsive to the agent availability event generates voice markup language that, when executed by a voice browser, interrupts the ongoing dialog to query whether the call is to be transferred to an available agent.

12. The call handling system of claim 11, wherein the SIP servlet selectively routes the call to the automated call distributor according to an instruction received from the reusable dialog component, wherein the instruction is determined according to user input received over the call.

13. A computer program product comprising a computer usable medium having a computer readable program, wherein the computer readable program, when executed on a computer, causes the computer to perform the steps of:
conducting a dialog with a calling party over an established call;
determining that an agent is available during the dialog;
interrupting the dialog; and
selectively terminating the dialog and transferring the call to the agent based upon a response from the calling party.

14. The computer program product of claim 13, wherein conducting a dialog further comprises:
routing the call to an automatic call distributor;
determining that no agent is available; and
registering a Session Initiation Protocol (SIP) servlet for receiving agent availability events from the automatic call distributor.

15. The computer program product of claim 14, wherein conducting a dialog further comprises:
launching a voice browser session; and
a hypertext transfer protocol (HTTP) servlet that hosts a reusable dialog component launching the reusable dialog component, wherein the reusable dialog component provides voice markup language for use with the voice browser session to implement the dialog.

16. The computer program product of claim 15, wherein determining that an agent is available further comprises:
the SIP servlet receiving an event indicating that the agent is available, wherein the event originates from the automatic call distributor;
the HTTP servlet receiving a notification of the availability of the agent from the SIP servlet; and
the reusable dialog component receiving a notification of the availability of the agent from the HTTP servlet.

17. The computer program product of claim 16, wherein interrupting the dialog further comprises the reusable dialog component, responsive to receiving the event from the HTTP servlet, generating voice markup language for use in the voice browser session to prompt the calling party as to the availability of the agent.

18. The computer program product of claim 17, wherein selectively terminating the dialog and transferring the call further comprises the reusable dialog component terminating the dialog based upon a response from the calling party.

19. The computer program product of claim 18, wherein selectively transferring the call further comprises:
the reusable dialog component notifying the SIP servlet that the dialog is terminated and requesting that the SIP servlet continue the call; and
the SIP servlet proxying the call to the automatic call distributor for routing to the agent.

20. The computer program product of claim 19, further causing the computer to provide data collected by the reusable dialog component to a client system associated with the agent.
